(19) United States
(12) Patent Application Publication
(10) Pub. No.: US 2026/0265517 A1
(43) Pub. Date: Sep. 10, 2026

(54) BIOPLASTIC POLYMERS AND COMPOSITIONS, ARTICLES, AND METHODS OF MAKING THE SAME

(71) Applicant: INGEVITY UK LTD, Cheshire (GB)

(72) Inventors: Luis Enriquez, Cheshire (GB); Norman W. Keane, Cheshire (GB)

(21) Appl. No.: 19/491,344

(22) PCT Filed: Jun. 26, 2024
(86) PCT No.: PCT/EP2024/068026

§ 371 Date: Dec. 8, 2025

Related U.S. Application Data
(60) Provisional application No. 63/510,230, filed on Jun. 26, 2023.
(60) Provisional application No. 63/549,257, filed on Feb. 2, 2024.

(51) Int. Cl. C08L 67/04; B29B 9/06; B29K 67/00

(52) U.S. Cl. CPC C08L 67/04; B29B 9/06; B29K 2067/04; C08L 2201/06; C08L 2205/025

(57) ABSTRACT

A bioplastic polymer or composition or article including the same are described herein. The bioplastic polymer or composition includes at least one polycaprolactone (PCL) and at least one bioplastic. The bioplastic polymer or composition described herein has increased/enhanced degradation/biodegradation characteristics, such as marine degradation/biodegradation characteristics (e.g., aerobic biodegradation and/or bio-disintegration in seawater), relative to the at least one bioplastic alone. A method of making a bioplastic polymer or composition is further described herein. The method includes admixing or mixing at least one PCL and at least one bioplastic to prepare a PCL-bioplastic blend or mixture; and blending the PCL-bioplastic blend or mixture to produce the bioplastic polymer or composition.

### CROSS-REFERENCE TO RELATED APPLICATIONS

This applications claims priority to, and the benefit of, U.S. Provisional Patent Application No. 63/510,230, filed 26 Jun. 2023, and U.S. Provisional Patent Application No. 63/549,257, filed 2 Feb. 2024, each of which is incorporated by reference herein in its entirety for all purposes.

### BACKGROUND OF THE INVENTION

Field of the Discovery. The present disclosure relates to bioplastic polymers or compositions, articles including bioplastic polymers or compositions of the present disclosure, and methods for preparing and using the biobased polymers or compositions of the present disclosure.

Background Information Billions of pounds of trash and other pollutants enter the oceans each year. This debris accumulates in the ocean with some sinking, being mistakenly eat by wild-life, washing ashore, etc. With the use of plastics continually growing, there is a need for biodegradable plastics that are sufficiently marine biodegradable. Whether a plastic is biodegradable or non-degradable (also referred to as durable) depends on the molecular structure of the plastic, not whether the plastic is a fossil-fuel plastic (also referred to as petro-based polymers), which are derived from petroleum or natural gas.

While degradable plastics exist, there is currently few plastics (such as bioplastics) with adequate marine biodegradation characteristics. Biodegradability of the plastic is highly dependent on the structure of the chemical backbone of the polymer. Furthermore, because plastics (such as bioplastics) have different chemical structures, biodegradability/disintegratability of different plastics (such as bioplastics) will vary depending upon the environment. For example, while polylactic acid (PLA), polybutylene succinate (PBS), and polydroxyalkanoate (PHA) bioplastic adequately degrade in some environments, these bioplastics do not adequately degrade in marine environments. For example, as shown on DRRR-2012-1435. State of California: California Department of Resources Recycling and Recovery. 5 Mar. 2012), there was minimal, if any, marine biodegradation of PLA after 365 days. Similarly, Royer et al. (Not so biodegradable: Polylactic acid and cellulose/plastic blend textiles lack fast biodegradation in marine waters. PLOS One. 2023. 18 (5): e0284681) did not observe marine biodegradation of PLA after 423 days. The problem is even worse for fossil-fuel plastics, such as polyethylene (PE) and polypropylene (PP).

Polycaprolactone (PCL) is a polymer with outstanding biodegradation mechanisms. As such, PCL biodegrades in many different environments. For example, PCL achieves adequate biodegradation for composting (e.g., home composting or industrial composting), trays for growing seedlings (soil biodegradation), and marine environments. PCL has also been shown to accelerate biodegradation in blends with other bioplastics. For example, while PLA does not fulfill the requirements to achieve acceptable biodegradation in home compositing (Naranci et al.), a blend of PLA with 20% CAPA® PCL thermoplastic resulted in acceptable biodegradation under home composting conditions.

Thus, there remains a need in the art for alternatives to plastics that meet and exceed marine biodegradation requirements, while providing good/acceptable characteristics for a plastic. The present disclose describes novel bioplastic polymer or composition that surprisingly and unexpectedly has increased/enhanced degradation/biodegradation characteristics, such as marine degradation/biodegradation characteristics (such as, aerobic biodegradation and/or bio-disintegration in seawater), relative to presently known plastics. The present disclosure further provides articles comprising the bioplastic polymer or composition of the present disclosure, as well as methods of making the bioplastic polymer or composition of the present disclosure.

### SUMMARY

Presently described are bioplastic polymers or compositions, articles comprising the bioplastic polymers or compositions, and methods of preparing the same.

Thus, in an aspect, the present disclosure provides a bioplastic polymer or composition comprising, consisting of, or consisting essentially of: at least one (e.g., 1, 2, 3, 4, 5, 6, or more) polycaprolactone (PCL) and at least one (e.g., 1, 2, 3, 4, 5, 6, or more) bioplastic.

In any aspect or embodiment described herein, one or more (e.g., 1, 2, 3, 4, 5, 6, or more) of the at least one polycaprolactone includes or is a thermoplastic polycaprolactone.

In any aspect or embodiment described herein, one or more (e.g., 1, 2, 3, 4, 5, 6, or more) of the at least one bioplastic includes or is a polysaccharide-based bioplastic, a protein-based bioplastic, an aliphatic bio-polyester, a bio-derived polyethylene, a lipid-based bioplastic, or a mixture thereof.

In any aspect or embodiment described herein, one or more (e.g., 1, 2, 3, 4, 5, 6, or more) of the at least one bioplastic includes or is derived from polysaccharides (e.g., starch, cellulose, chitosan, alginate, or a combination thereof), protein (e.g., soy protein, gluten, gelatin, or a combination thereof), lipids (e.g., oils, facts, vegetable oil, vegetable fat, or a combination thereof), or a mixture thereof.

In any aspect or embodiment described herein, one or more (e.g., 1, 2, 3, 4, 5, 6, or more) of the at least one bioplastic includes or is a polylactic acid (PLA) bioplastic, a polyhydroxybutyrate (PHB) bioplastic, a thermoplastic starch (TPS) bioplastic, a poly(1,4-butylene succinate) (PBS) bioplastic, a polyhydroxyalkanoates (PHA) bioplastic, or a mixture thereof.

In any aspect or embodiment described herein, the at least one polycaprolactone is present in an amount of about 5.0 wt % to about 50.0 wt % (e.g., about 20.0 wt % to about 50.0 wt % or about 20.0 wt % to about 40.0 wt %) of the bioplastic polymer or composition.

In any aspect or embodiment described herein, the at least one bioplastic is present in an amount of about 50.0 wt % to about 95.0 wt % (e.g., about 50.0 wt % to about 80.0 wt % or about 60.0 wt % to about 80.0 wt %) of the bioplastic polymer or composition.

In any aspect or embodiment described herein, the bioplastic polymer or composition is a thermoplastic bioplastic polymer or composition (e.g., one or more (e.g., 1, 2, 3, 4, 5, 6, or more) of the at least one polycaprolactone is a thermoplastic polycaprolactone).

In any aspect or embodiment described herein, the bioplastic polymer or composition has an acceptable glass transition temperature (e.g., within 10.0% of the glass transition temperature of the bioplastic not blended/polymerized with PCL), an acceptable melting temperature (e.g., within 10.0% of the melting temperature of the bioplastic not blended/polymerized with PCL), an acceptable crystallization (e.g., within 10.0% of the crystallization temperature of the bioplastic not blended/polymerized with PCL), an acceptable specific heat capacity (e.g., within 10.0% of the specific heat capacity of the bioplastic not blended/polymerized with PCL), an acceptable oxidation behavior (e.g., within 10.0% of the oxidation behavior of the bioplastic not blended/polymerized with PCL), an acceptable thermal stability (e.g., within 10.0% of the thermal stability of the bioplastic not blended/polymerized with PCL), an acceptable tensile strength (e.g., within 10.0% of the tensile strength of the bioplastic not blended/polymerized with PCL), an acceptable compressive strength (e.g., within 10.0% of the compressive strength of the bioplastic not blended/polymerized with PCL), an acceptable impact strength (e.g., within 10.0% of the impact strength of the bioplastic not blended/polymerized with PCL), an acceptable marine aerobic biodegradation (e.g., at least 90.0% biodegradation with a plateau reached within 6-months), an acceptable bio-disintegration in seawater (e.g., falls apart and/or fragmentation (<2 mm)), an acceptable Daphnia magna toxicity (e.g., at least 90.0% of the tested organisms remain mobile), or a combination thereof.

Another aspect of the present disclosure provides a bioplastic polymer or composition of the present disclosure made by a process comprising, consisting of, or consisting essentially of: admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition.

A further aspect of the present disclosure provides a method of making the bioplastic polymer or composition of the present disclosure. The method comprises, consisting essentially of, or consisting of admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition.

In any aspect or embodiment described herein, blending (e.g., blending with an extruder or polymerizing) the PCL-bioplastic blend or mixture includes heating, mixing, or a combination thereof, the PCL-bioplastic blend or mixture.

In any aspect or embodiment described herein, the process or method further comprises drying the at least one bioplastic (e.g., dry to a level of less than about 250 parts per million (PPM)).

In any aspect or embodiment described herein, the process or method further about 80° C. to about 120° C. (e.g., for about 1 hour to about 10 hours, about 2 hours or about 8 hours, or about 4 hours to about 6 hours).

In any aspect or embodiment described herein, the process or method further comprises extruding the bioplastic polymer or composition.

In any aspect or embodiment described herein, the process or method further comprises cooling the extruded bioplastic polymer or composition (e.g., cooling the extruded bioplastic polymer or composition with a water bath).

In any aspect or embodiment described herein, the process or method further comprises pelletizing the extruded bioplastic polymer or composition (e.g., bioplastic polymer or composition filament).

In any aspect or embodiment described herein, one or more (e.g., 1, 2, 3, 4, 5, 6, or more) of the at least one polycaprolactone is a thermoplastic polycaprolactone.

In any aspect or embodiment described herein, one or more (e.g., 1, 2, 3, 4, 5, 6, or more) of the at least one bioplastic includes a polysaccharide-based bioplastic, a protein-based bioplastic, an aliphatic bio-polyester, a bio-derived polyethylene, a lipid-based bioplastic, or a mixture thereof.

In any aspect or embodiment described herein, one or more (e.g., 1, 2, 3, 4, 5, 6, or more) of the at least one bioplastic includes or is derived from polysaccharides (e.g., starch, cellulose, chitosan, alginate, or a combination thereof), protein (e.g., soy protein, gluten, gelatin, or a combination thereof), lipids (e.g., oils, facts, vegetable oil, vegetable fat, or a combination thereof), or a mixture thereof.

In any aspect or embodiment described herein, one or more (e.g., 1, 2, 3, 4, 5, 6, or more) of the at least one bioplastic includes or is a polylactic acid (PLA) bioplastic, a polyhydroxybutyrate (PHB) bioplastic, a thermoplastic starch (TPS) bioplastic, a poly(1,4-butylene succinate) (PBS) bioplastic, a polyhydroxyalkanoates (PHA) bioplastic, or a mixture thereof.

In any aspect or embodiment described herein, the at least one polycaprolactone is present in an amount of about 5.0 wt % to about 50.0 wt % (e.g., about 20.0 wt % to about 50.0 wt % or about 20.0 wt % to about 40.0 wt %) of the bioplastic composition.

In any aspect or embodiment described herein, the at least one bioplastic is present in an amount of about 50.0 wt % to about 95.0 wt % (e.g., about 50.0 wt % to about 80.0 wt % or about 60.0 wt % to about 80.0 wt %) of the bioplastic composition.

An additional aspect of the present disclosure provides an article comprising, consisting essentially of, or consisting of, the bioplastic polymer or composition of the present disclosure.

The preceding general areas of utility are given by way of example only and are not intended to be limiting on the scope of the present disclosure and appended claims. Additional objects and advantages associated with the polymers, compositions, methods, and processes of the present disclosure will be appreciated by one of ordinary skill in the art in light of the instant claims, description, and examples. For example, the various aspects and embodiments of the present disclosure can be utilized in numerous combinations, all of which are expressly contemplated by the present disclosure. These additional advantages objects and embodiments are expressly included within the scope of the present disclosure. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present disclosure and, together with the description, serve to explain the principles of the disclosure. The drawings are only for the purpose of illustrating an embodiment of the disclosure and are not to be construed as limiting the disclosure. Further objects, features and advantages of the disclosure will become apparent from the following detailed description taken in conjunction with the accompanying figures showing illustrative embodiments of the disclosure.

FIG. 1 illustrates the marine aerobic biodegradation of Avicel® native cellulose (SIGMA-ALDRICH, Saint Louis, Missouri) and CAPA® 6800D (INGEVITY UK LTD, North Charleston, South Carolina) over 154 days.

FIG. 2 shows the evolution of biodegradation percentages of reference and test items.

FIG. 3 shows the evolution of the biodegradation of replicates of cellulose in Replicate No. 2 (RN2) and Replicate No. 7 (RN7).

FIG. 4 shows the evolution of the biodegradation of replicates of Sample 3 (polycaprolactone (PCL): polylactic acid (PLA) is 20:80), wherein PCL is CAPA® 6800 (INGEVITY UK LTD, Warrington, Chesire, United Kingdom), in Replicate No. 3 (RN3) and Replicate No. 8 (RN8).

FIG. 5 shows the evolution of the biodegradation of replicates of Sample 4 (PCL: PLA is 30:70), wherein PCL is CAPA® 6800 (INGEVITY UK LTD, Warrington, Chesire, United Kingdom), in Replicate No. 4 (RN4) and Replicate No. 9 (RN9).

FIG. 6 shows the evolution of the biodegradation of replicates of Sample 5 (PCL:PLA is 40:60), wherein PCL is CAPA® 6800 (INGEVITY UK LTD, Warrington, Chesire, United Kingdom), in Replicate No. 5 (RN5) and Replicate No. 10 (RN10).

### DETAILED DESCRIPTION

The present disclosure will now be described more fully hereinafter, but not all embodiments of the disclosure are shown. While the disclosure has been described with reference to exemplary embodiments, it will be understood by those skilled in the art that various changes can be made and equivalents can be substituted for elements thereof without departing from the scope of the disclosure. In addition, many modifications can be made to adapt a particular structure or material to the teachings of the disclosure without departing from the essential scope thereof.

Where a range of values is provided, it is understood that each intervening value between the upper and lower limit of that range and any other stated or intervening value in that stated range is encompassed within the invention. The upper and lower limits of these smaller ranges can independently be included in the smaller ranges is also encompassed within the invention, subject to any specifically excluded limit in the stated range. Where the stated range includes one or both of the limits, ranges excluding either both of those included limits are also included in the present disclosure.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

As used herein in the specification and in the claims, “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the 10 United States Patent Office Manual of Patent Examining Procedures, Section 2111.03.

It should also be understood that, unless clearly indicated to the contrary, in any methods claimed herein that include more than one step or act, the order of the steps or acts of the method is not necessarily limited to the order in which the steps or acts of the method are recited.

Surprisingly and unexpectedly, the inventors found that the bioplastic polymer or composition of the present disclosure has increased/enhanced degradation/biodegradation characteristics, such as marine degradation/biodegradation characteristics (such as, aerobic biodegradation and/or bio-disintegration in seawater), relative to presently known plastics. In any aspect or embodiment described herein, the bioplastic polymer or composition comprising, consisting of, or consisting essentially of: at least one (e.g., 1, 2, 3, 4, 5, 6, or more) polycaprolactone (PCL) and at least one (e.g., 1, 2, 3, 4, 5, 6, or more) bioplastic. Furthermore, in any aspect or embodiment described herein, the bioplastic polymer or composition of the present disclosure is made by a process comprising, consisting of, or consisting essentially of: admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition.

### Bioplastic Polymers or Compositions of the Disclosure and Articles Comprising the Same

An aspect of the present disclosure provides a bioplastic polymer or composition comprising: at least one (e.g., 1, 2, 3, 4, 5, 6, or more) polycaprolactone (PCL) and at least one (e.g., 1, 2, 3, 4, 5, 6, or more) bioplastic. Another aspect of the present disclosure provides a bioplastic polymer or composition consisting essentially of: at least one (e.g., 1, 2, 3, 4, 5, 6, or more) polycaprolactone (PCL) and at least one (e.g., 1, 2, 3, 4, 5, 6, or more) bioplastic. A further aspect of the present disclosure provides a bioplastic polymer or composition consisting of: at least one (e.g., 1, 2, 3, 4, 5, 6, or more) polycaprolactone (PCL) and at least one (e.g., 1, 2, 3, 4, 5, 6, or more) bioplastic.

An aspect of the present disclosure provides a bioplastic polymer or composition of the present disclosure made by a process comprising: admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition. Another aspect of the present disclosure provides a bioplastic polymer or composition of the present disclosure made by a process consisting essentially of: admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition. A further aspect of the present disclosure provides a bioplastic polymer or composition of the present disclosure made by a process consisting of: admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition.

An aspect of the present disclosure provides an article comprising the bioplastic polymer or composition of the present disclosure. Another aspect of the present disclosure provides an article consisting essentially of the bioplastic polymer or composition of the present disclosure. A further aspect of the present disclosure provides an article consisting of the bioplastic polymer or composition of the present disclosure.

In any aspect or embodiment described herein, one or more (e.g., 1, 2, 3, 4, 5, 6, or more) of the at least one polycaprolactone includes or is a thermoplastic polycaprolactone. In any aspect or embodiment described herein, one or more of the at least one polycaprolactone has a molecule weight (MW) of about 10,000 to about 100,000 g/mol. For example, in any aspect or embodiment described herein, one or more of the at least one polycaprolactone has a MW of about 10000 to about 100000, about 10000 to about 90000, about 10000 to about 80000, about 10000 to about 70000, about 10000 to about 60000, about 10000 to about 50000, about 10000 to about 40000, about 10000 to about 30000, about 20000 to about 100000, about 20000 to about 90000, about 20000 to about 80000, about 20000 to about 70000, about 20000 to about 60000, about 20000 to about 50000, about 20000 to about 40000, about 30000 to about 100000, about 30000 to about 90000, about 30000 to about 80000, about 30000 to about 70000, about 30000 to about 60000, about 30000 to about 50000, about 40000 to about 100000, about 40000 to about 90000, about 40000 to about 80000, about 40000 to about 70000, about 40000 to about 60000, about 50000 to about 100000, about 50000 to about 90000, about 50000 to about 80000, about 50000 to about 70000, about 60000 to about 80000, about 60000 to about 100000, about 60000 to about 90000, about 70000 to about 100000, about 70000 to about 90000, or about 80000 to about 100000 g/mol.

In any aspect or embodiment described herein, one or more (e.g., 1, 2, 3, 4, 5, 6, or more) of the at least one bioplastic includes or is a polysaccharide-based bioplastic, a protein-based bioplastic, an aliphatic bio-polyester, a bio-derived polyethylene, a lipid-based bioplastic, or a mixture thereof.

In any aspect or embodiment described herein, one or more (e.g., 1, 2, 3, 4, 5, 6, or more) of the at least one bioplastic includes or is derived from polysaccharides (e.g., starch, cellulose, chitosan, alginate, or a combination thereof), protein (e.g., soy protein, gluten, gelatin, or a combination thereof), lipids (e.g., oils, facts, vegetable oil, vegetable fat, or a combination thereof), or a mixture thereof.

In any aspect or embodiment described herein, one or more (e.g., 1, 2, 3, 4, 5, 6, or more) of the at least one bioplastic includes or is a polylactic acid (PLA) bioplastic, a polyhydroxybutyrate (PHB) bioplastic, a thermoplastic starch (TPS) bioplastic, a poly(1,4-butylene succinate) (PBS) bioplastic, a polyhydroxyalkanoates (PHA) bioplastic, or a mixture thereof.

In any aspect or embodiment described herein, the at least one polycaprolactone is present in an amount of about 5.0 wt % to about 50.0 wt % (e.g., about 20.0 wt % to about 50.0 wt % or about 20.0 wt % to about 40.0 wt %) of the bioplastic polymer or composition. For example, in any aspect or embodiment described herein, the at least one polycaprolactone is present in an amount of about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 5.0 wt % to about 10.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 10.0 wt % to about 15.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 15.0 wt % to about 20.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 20.0 wt % to about 25.0 wt %, about 25.0 wt % to about 50.0 wt %, about 25.0 wt % to about 45.0 wt %, about 25.0 wt % to about 40.0 wt %, about 25.0 wt % to about 35.0 wt %, about 25.0 wt % to about 30.0 wt %, about 30.0 wt % to about 50.0 wt %, about 30.0 wt % to about 45.0 wt %, about 30.0 wt % to about 40.0 wt %, about 30.0 wt % to about 35.0 wt %, about 35.0 wt % to about 50.0 wt %, about 35.0 wt % to about 45.0 wt %, about 35.0 wt % to about 40.0 wt %, about 40.0 wt % to about 50.0 wt %, about 40.0 wt % to about 45.0 wt %, or about 45.0 wt % to about 50.0 wt % of the bioplastic polymer or composition.

In any aspect or embodiment described herein, the at least one bioplastic is present in an amount of about 50.0 wt % to about 95.0 wt % (e.g., about 50.0 wt % to about 80.0 wt % or about 60.0 wt % to about 80.0 wt %) of the bioplastic polymer or composition. For example, in any aspect or embodiment described herein, the at least one bioplastic is present in an amount of about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 50.0 wt % to about 55.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 55.0 wt % to about 60.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 60.0 wt % to about 65.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 65.0 wt % to about 70.0 wt %, about 70.0 wt % to about 95.0 wt %, about 70.0 wt % to about 90.0 wt %, about 70.0 wt % to about 85.0 wt %, about 70.0 wt % to about 80.0 wt %, about 70.0 wt % to about 75.0 wt %, about 80.0 wt % to about 95.0 wt %, about 80.0 wt % to about 90.0 wt %, about 80.0 wt % to about 85.0 wt %, about 85.0 wt % to about 95.0 wt %, about 85.0 wt % to about 90.0 wt %, about 90.0 wt % to about 95.0 wt % of the bioplastic polymer or composition.

In any aspect or embodiment described herein, the bioplastic polymer or composition is a thermoplastic bioplastic polymer or composition (e.g., one or more (e.g., 1, 2, 3, 4, 5, 6, or more) of the at least one polycaprolactone is a thermoplastic polycaprolactone).

In any aspect or embodiment described herein, the bioplastic polymer or composition has an acceptable glass transition temperature (e.g., within 10.0%, 9.0%, 8.0%, 7.0%, 6.0%, 5.0%, 4.0%, 3.0%, 2.0%, or 1.0% of the glass transition temperature of the bioplastic not blended/polymerized with PCL). In any aspect or embodiment described herein, the bioplastic polymer or composition has an acceptable melting temperature (e.g., within 10.0%, 9.0%, 8.0%, 7.0%, 6.0%, 5.0%, 4.0%, 3.0%, 2.0%, or 1.0% of the melting temperature of the bioplastic not blended/polymerized with PCL). In any aspect or embodiment described herein, the bioplastic polymer or composition has an acceptable crystallization temperature (e.g., within 10.0%, 9.0%, 8.0%, 7.0%, 6.0%, 5.0%, 4.0%, 3.0%, 2.0%, or 1.0% of the crystallization temperature of the bioplastic not blended/polymerized with PCL). In any aspect or embodiment described herein, the bioplastic polymer or composition has an acceptable specific heat capacity (e.g., within 10.0%, 9.0%, 8.0%, 7.0%, 6.0%, 5.0%, 4.0%, 3.0%, 2.0%, or 1.0% of the specific heat capacity of the bioplastic not blended/polymerized with PCL). In any aspect or embodiment described herein, the bioplastic polymer or composition has an acceptable oxidation behavior (e.g., within 10.0%, 9.0%, 8.0%, 7.0%, 6.0%, 5.0%, 4.0%, 3.0%, 2.0%, or 1.0% of the oxidation behavior of the bioplastic not blended/polymerized with PCL). In any aspect or embodiment described herein, the bioplastic polymer or composition has an acceptable thermal stability (e.g., within 10.0%, 9.0%, 8.0%, 7.0%, 6.0%, 5.0%, 4.0%, 3.0%, 2.0%, or 1.0% of the thermal stability of the bioplastic not blended/polymerized with PCL). In any aspect or embodiment described herein, the bioplastic polymer or composition has an acceptable tensile strength (e.g., within 10.0%, 9.0%, 8.0%, 7.0%, 6.0%, 5.0%, 4.0%, 3.0%, 2.0%, or 1.0% of the tensile strength of the bioplastic not blended/polymerized with PCL). In any aspect or embodiment described herein, the bioplastic polymer or composition has an acceptable compressive strength (e.g., within 10.0%, 9.0%, 8.0%, 7.0%, 6.0%, 5.0%, 4.0%, 3.0%, 2.0%, or 1.0% of the compressive strength of the bioplastic not blended/polymerized with PCL). impact strength (e.g., within 10.0%, 9.0%, 8.0%, 7.0%, 6.0%, 5.0%, 4.0%, 3.0%, 2.0%, or 1.0% of the bioplastic not blended/polymerized with PCL). In any aspect or embodiment described herein, the bioplastic polymer or composition has an acceptable marine aerobic biodegradation (e.g., at least 90.0% marine aerobic biodegradation with a plateau reached within 6-months). In any aspect or embodiment described herein, the bioplastic polymer or composition has an acceptable bio-disintegration in seawater (e.g., falls apart and/or fragmentation (<2 mm)). In any aspect or embodiment described herein, the bioplastic polymer or composition has an acceptable Daphnia magna toxicity (e.g., at least 90.0% of the tested organisms remain mobile).

In any aspect or embodiment described herein, blending (e.g., blending with an extruder or polymerizing) the PCL-bioplastic blend or mixture includes heating, mixing, or a combination thereof, the PCL-bioplastic blend or mixture.

In any aspect or embodiment described herein, the process or method further comprises drying the at least one bioplastic (e.g., dry to a level of less than about 250.0 parts per million (PPM)). For example, in any aspect or embodiment described herein, the process or method further comprises drying the at least one bioplastic to a level of less than about 300.0, less than about 275.0, less than about 250.0, less than about 225.0, less than about 200.0, less than about 175.0, or less than about 150.0 PPM.

In any aspect or embodiment described herein, the process or method further about 80° C. to about 120° C. For example, in any aspect or embodiment described herein, the process or method further comprises heating (e.g., as part of drying the at least one bioplastic) the at least one bioplastic to about 80° C. to about 120° C., about 80° C. to about 110° C., about 80° C. to about 100° C., about 80° C. to about 90° C., about 90° C. to about 120° C., about 90° C. to about 110° C., about 90° C. to about 100° C., about 100° C. to about 120° C., about 100° C. to about 110° C., or about 110° C. to about 120° C.

In any aspect or embodiment described herein, the process or method further comprises heating (e.g., as part of drying the at least one bioplastic) the at least one bioplastic for about 1 hour to about 10 hours. For example, in any aspect or embodiment described herein, the process or method further comprises heating (e.g., as part of drying the at least one bioplastic) the at least one bioplastic for about 1 hour to about 10 hours, about 1 hour to about 9 hours, about 1 hour to about 8 hours, about 1 hour to about 7 hours, about 1 hour to about 6 hours, about 1 hour to about 5 hours, about 1 hour to about 4 hours, about 1 hour to about 3 hours, about 1 hour to about 2 hours, about 2 to about 10 hours, about 2 to about 9 hours, about 2 to about 8 hours, about 2 to about 7 hours, about 2 to about 6 hours, about 2 to about 5 hours, about 2 to about 4 hours, about 2 to about 3 hours, about 32 to about 10 hours, about 3 to about 9 hours, about 3 to about 8 hours, about 3 to about 7 hours, about 3 to about 6 hours, about 3 to about 5 hours, about 3 to about 4 hours, about 4 to about 10 hours, about 4 to about 9 hours, about 4 to about 8 hours, about 4 to about 7 hours, about 4 to about 6 hours, about 4 to about 5 hours, about 5 to about 10 hours, about 5 to about 9 hours, about 5 to about 8 hours, about 5 to about 7 hours, about 5 to about 6 hours, about 6 to about 10 hours, about 6 to about 9 hours, about 6 to about 8 hours, about 6 to about 7 hours, about 7 to about 10 hours, about 7 to about 9 hours, about 7 to about 8 hours, about 8 to about 10 hours, about 8 to about 9 hours, or about 9 to about 10 hours.

In any aspect or embodiment described herein, the process or method further comprises extruding the bioplastic polymer or composition.

In any aspect or embodiment described herein, the process or method further comprises cooling the extruded bioplastic polymer or composition. For example, in any aspect or embodiment described herein, the process or method further comprises cooling the extruded bioplastic polymer or composition with a water bath.

In any aspect or embodiment described herein, the process or method further comprises pelletizing the extruded bioplastic polymer or composition (e.g., bioplastic polymer or composition filament).

As used herein, the term “polycaprolactone” (PCL) is a polymer of caprolactone monomers. As used herein, the term “caprolactone” is intended to encompass unsubstituted caprolactone and substituted caprolactone, such as ε-caprolactone. The term “¿-caprolactone” is intended to encompass unsubstituted ε-caprolactone and substituted ε-caprolactone. Unsubstituted ε-caprolactone is particularly preferred.

In any aspect or embodiment described herein, the PCL is a mixture of different caprolactones, such as substituted or unsubstituted ¿-caprolactone and/or a mixture of caprolactones having different substituents.

In any aspect or embodiment described herein, substituted caprolactone monomers, such as ε-caprolactone monomers, that may be used in the production of the PCL include C₁₋₁₂ alkyl substituted ε-caprolactone, C₁₋₁₂ alkenyl substituted ε-caprolactone, C₁₋₁₂ alkynyl substituted ε-caprolactone, C₁₋₁₈ cycloalkyl substituted ε-caprolactone, C₁₋₁₂ alkoxy substituted ε-caprolactone, C₁₋₁₈ aryl substituted ε-caprolactone, C₁₋₁₈ alkaryl substituted ε-caprolactone, C₁₋₁₈ aralkyl substituted ε-caprolactone, C₁₋₁₈ aryloxy substituted ε-caprolactone, and mixtures thereof.

In any aspect or embodiment described herein, substituted ε-caprolactone monomers that may be present in the PCL include mono-, di- or tri-substituted monomers. In any aspect or embodiment described herein, exemplary substituted-caprolactone monomers include monomethyl ε-caprolactone, monoethyl ε-caprolactone, monopropyl ε-caprolactone, monomethoxy ε-caprolactone, monoethoxy ε-caprolactone, monopropoxy ε-caprolactone, monobenzyl ε-caprolactone, monophenyl ε-caprolactone, dimethyl ε-caprolactone, diethyl ε-caprolactone, dipropyl ε-caprolactone, dimethoxy ε-caprolactone, diethoxy ε-caprolactone, dipropoxy ε-caprolactone, dibenzyl ε-caprolactone, diphenyl ε-caprolactone, and mixtures thereof.

In any aspect or embodiment described herein, the bioplastic polymer or composition further comprises calcium carbonate, talc, zinc stearate, wood flour, microballoon, silicon dioxide, chitosan, clay, bentonite, cellulose, carboxymethyl cellulose, kaolin, kaolinite, mica, silk fibroin nanoparticles, or a combination thereof.

### Methods of Making the Bioplastic Polymers or Compositions of the Disclosure

An aspect of the present disclosure provides a method of making the bioplastic polymer or composition of the present disclosure, the method comprises admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition. Another aspect of the present disclosure provides a method of making the bioplastic polymer or composition of the present disclosure, the method consisting essentially of admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition. A further aspect of the present disclosure provides a method of making the bioplastic polymer or composition of the present disclosure, the method consisting of admixing or mixing at least one (e.g., 1, 2, 3, 4, 5, 6, or more) polycaprolactone (PCL) and at least one (e.g., 1, 2, 3, 4, 5, 6, or more) bioplastic to prepare a PCL-bioplastic blend or mixture; and blending (e.g., blending with an extruder or polymerizing) the PCL-bioplastic blend or mixture to produce the bioplastic polymer or composition.

In any aspect or embodiment described herein, blending (e.g., blending with an extruder or polymerizing) the PCL-bioplastic blend or mixture includes heating, mixing, or a combination thereof, the PCL-bioplastic blend or mixture.

In any aspect or embodiment described herein, the process or method further comprises drying the at least one bioplastic (e.g., dry to a level of less than about 250.0 parts per million (PPM)). For example, in any aspect or embodiment described herein, the process or method further comprises drying the at least one bioplastic to a level of less than about 300.0, less than about 275.0, less than about 250.0, less than about 225.0, less than about 200.0, less than about 175.0, or less than about 150.0 PPM.

In any aspect or embodiment described herein, the process or method further about 80° C. to about 120° C. For example, in any aspect or embodiment described herein, the process or method further comprises heating (e.g., as part of drying the at least one bioplastic) the at least one bioplastic to about 80° C. to about 120° C., about 80° C. to about 110° C., about 80° C. to about 100° C., about 80° C. to about 90° C., about 90° C. to about 120° C., about 90° C. to about 110° C., about 90° C. to about 100° C., about 100° C. to about 120° C., about 100° C. to about 110° C., or about 110° C. to about 120° C.

In any aspect or embodiment described herein, the process or method further comprises heating (e.g., as part of drying the at least one bioplastic) the at least one bioplastic for about 1 hour to about 10 hours. For example, in any aspect or embodiment described herein, the process or method further comprises heating (e.g., as part of drying the at least one bioplastic) the at least one bioplastic for about 1 hour to about 10 hours, about 1 hour to about 9 hours, about 1 hour to about 8 hours, about 1 hour to about 7 hours, about 1 hour to about 6 hours, about 1 hour to about 5 hours, about 1 hour to about 4 hours, about 1 hour to about 3 hours, about 1 hour to about 2 hours, about 2 to about 10 hours, about 2 to about 9 hours, about 2 to about 8 hours, about 2 to about 7 hours, about 2 to about 6 hours, about 2 to about 5 hours, about 2 to about 4 hours, about 2 to about 3 hours, about 32 to about 10 hours, about 3 to about 9 hours, about 3 to about 8 hours, about 3 to about 7 hours, about 3 to about 6 hours, about 3 to about 5 hours, about 3 to about 4 hours, about 4 to about 10 hours, about 4 to about 9 hours, about 4 to about 8 hours, about 4 to about 7 hours, about 4 to about 6 hours, about 4 to about 5 hours, about 5 to about 10 hours, about 5 to about 9 hours, about 5 to about 8 hours, about 5 to about 7 hours, about 5 to about 6 hours, about 6 to about 10 hours, about 6 to about 9 hours, about 6 to about 8 hours, about 6 to about 7 hours, about 7 to about 10 hours, about 7 to about 9 hours, about 7 to about 8 hours, about 8 to about 10 hours, about 8 to about 9 hours, or about 9 to about 10 hours.

In any aspect or embodiment described herein, the method further comprises extruding the bioplastic polymer or composition.

In any aspect or embodiment described herein, the process or method further comprises cooling the extruded bioplastic polymer or composition. For example, in any aspect or embodiment described herein, the process or method further comprises cooling the extruded bioplastic polymer or composition with a water bath.

In any aspect or embodiment described herein, the method further comprises pelletizing the extruded bioplastic polymer or composition (e.g., bioplastic polymer or composition filament).

In any aspect or embodiment described herein, one or more (e.g., 1, 2, 3, 4, 5, 6, or more) of the at least one polycaprolactone includes or is a thermoplastic polycaprolactone. In any aspect or embodiment described herein, one or more of the at least one polycaprolactone has a molecule weight (MW) of about 10,000 to about 100,000 g/mol. For example, in any aspect or embodiment described herein, one or more of the at least one polycaprolactone has a MW of about 10000 to about 100000, about 10000 to about 90000, about 10000 to about 80000, about 10000 to about 70000, about 10000 to about 60000, about 10000 to about 50000, about 10000 to about 40000, about 10000 to about 30000, about 20000 to about 100000, about 20000 to about 90000, about 20000 to about 80000, about 20000 to about 70000, about 20000 to about 60000, about 20000 to about 50000, about 20000 to about 40000, about 30000 to about 100000, about 30000 to about 90000, about 30000 to about 80000, about 30000 to about 70000, about 30000 to about 60000, about 30000 to about 50000, about 40000 to about 100000, about 40000 to about 90000, about 40000 to about 80000, about 40000 to about 70000, about 40000 to about 60000, about 50000 to about 100000, about 50000 to about 90000, about 50000 to about 80000, about 50000 to about 70000, about 60000 to about 80000, about 60000 to about 100000, about 60000 to about 90000, about 70000 to about 100000, about 70000 to about 90000, or about 80000 to about 100000 g/mol.

In any aspect or embodiment described herein, one or more (e.g., 1, 2, 3, 4, 5, 6, or more) of the at least one bioplastic includes a polysaccharide-based bioplastic, a protein-based bioplastic, an aliphatic bio-polyester, a bio-derived polyethylene, a lipid-based bioplastic, or a mixture thereof.

In any aspect or embodiment described herein, one or more (e.g., 1, 2, 3, 4, 5, 6, or more) of the at least one bioplastic includes or is derived from polysaccharides (e.g., starch, cellulose, chitosan, alginate, or a combination thereof), protein (e.g., soy protein, gluten, gelatin, or a combination thereof), lipids (e.g., oils, facts, vegetable oil, vegetable fat, or a combination thereof), or a mixture thereof.

In any aspect or embodiment described herein, one or more (e.g., 1, 2, 3, 4, 5, 6, or more) of the at least one bioplastic includes or is a polylactic acid (PLA) bioplastic, a polyhydroxybutyrate (PHB) bioplastic, a thermoplastic starch (TPS) bioplastic, a poly(1,4-butylene succinate) (PBS) bioplastic, a polyhydroxyalkanoates (PHA) bioplastic, or a mixture thereof.

In any aspect or embodiment described herein, the at least one polycaprolactone is present in an amount of about 5.0 wt % to about 50.0 wt % (e.g., about 20.0 wt % to about 50.0 wt % or about 20.0 wt % to about 40.0 wt %) of the bioplastic polymer or composition. For example, in any aspect or embodiment described herein, the at least one polycaprolactone is present in an amount of about 5.0 wt % to about 50.0 wt %, about 5.0 wt % to about 45.0 wt %, about 5.0 wt % to about 40.0 wt %, about 5.0 wt % to about 35.0 wt %, about 5.0 wt % to about 30.0 wt %, about 5.0 wt % to about 25.0 wt %, about 5.0 wt % to about 20.0 wt %, about 5.0 wt % to about 15.0 wt %, about 5.0 wt % to about 10.0 wt %, about 10.0 wt % to about 50.0 wt %, about 10.0 wt % to about 45.0 wt %, about 10.0 wt % to about 40.0 wt %, about 10.0 wt % to about 35.0 wt %, about 10.0 wt % to about 30.0 wt %, about 10.0 wt % to about 25.0 wt %, about 10.0 wt % to about 20.0 wt %, about 10.0 wt % to about 15.0 wt %, about 15.0 wt % to about 50.0 wt %, about 15.0 wt % to about 45.0 wt %, about 15.0 wt % to about 40.0 wt %, about 15.0 wt % to about 35.0 wt %, about 15.0 wt % to about 30.0 wt %, about 15.0 wt % to about 25.0 wt %, about 15.0 wt % to about 20.0 wt %, about 20.0 wt % to about 50.0 wt %, about 20.0 wt % to about 45.0 wt %, about 20.0 wt % to about 40.0 wt %, about 20.0 wt % to about 35.0 wt %, about 20.0 wt % to about 30.0 wt %, about 20.0 wt % to about 25.0 wt %, about 25.0 wt % to about 50.0 wt %, about 25.0 wt % to about 45.0 wt %, about 25.0 wt % to about 40.0 wt %, about 25.0 wt % to about 35.0 wt %, about 25.0 wt % to about 30.0 wt %, about 30.0 wt % to about 50.0 wt %, about 30.0 wt % to about 45.0 wt %, about 30.0 wt % to about 40.0 wt %, about 30.0 wt % to about 35.0 wt %, about 35.0 wt % to about 50.0 wt %, about 35.0 wt % to about 45.0 wt %, about 35.0 wt % to about 40.0 wt %, about 40.0 wt % to about 50.0 wt %, about 40.0 wt % to about 45.0 wt %, or about 45.0 wt % to about 50.0 wt % of the bioplastic polymer or composition.

In any aspect or embodiment described herein, the at least one bioplastic is present in an amount of about 50.0 wt % to about 95.0 wt % (e.g., about 50.0 wt % to about 80.0 wt % or about 60.0 wt % to about 80.0 wt %) of the bioplastic polymer or composition. For example, in any aspect or embodiment described herein, the at least one bioplastic is present in an amount of about 50.0 wt % to about 95.0 wt %, about 50.0 wt % to about 90.0 wt %, about 50.0 wt % to about 85.0 wt %, about 50.0 wt % to about 80.0 wt %, about 50.0 wt % to about 75.0 wt %, about 50.0 wt % to about 70.0 wt %, about 50.0 wt % to about 65.0 wt %, about 50.0 wt % to about 60.0 wt %, about 50.0 wt % to about 55.0 wt %, about 55.0 wt % to about 95.0 wt %, about 55.0 wt % to about 90.0 wt %, about 55.0 wt % to about 85.0 wt %, about 55.0 wt % to about 80.0 wt %, about 55.0 wt % to about 75.0 wt %, about 55.0 wt % to about 70.0 wt %, about 55.0 wt % to about 65.0 wt %, about 55.0 wt % to about 60.0 wt %, about 60.0 wt % to about 95.0 wt %, about 60.0 wt % to about 90.0 wt %, about 60.0 wt % to about 85.0 wt %, about 60.0 wt % to about 80.0 wt %, about 60.0 wt % to about 75.0 wt %, about 60.0 wt % to about 70.0 wt %, about 60.0 wt % to about 65.0 wt %, about 65.0 wt % to about 95.0 wt %, about 65.0 wt % to about 90.0 wt %, about 65.0 wt % to about 85.0 wt %, about 65.0 wt % to about 80.0 wt %, about 65.0 wt % to about 75.0 wt %, about 65.0 wt % to about 70.0 wt %, about 70.0 wt % to about 95.0 wt %, about 70.0 wt % to about 90.0 wt %, about 70.0 wt % to about 85.0 wt %, about 70.0 wt % to about 80.0 wt %, about 70.0 wt % to about 75.0 wt %, about 80.0 wt % to about 95.0 wt %, about 80.0 wt % to about 90.0 wt %, about 80.0 wt % to about 85.0 wt %, about 85.0 wt % to about 95.0 wt %, about 85.0 wt % to about 90.0 wt %, about 90.0 wt % to about 95.0 wt % of the bioplastic polymer or composition.

In any aspect or embodiment described herein, the process or method further comprises cooling the extruded bioplastic polymer or composition. For example, in any aspect or embodiment described herein, the process or method further comprises cooling the extruded bioplastic polymer or composition with a water bath.

### EXAMPLES

The details of the examples are contemplated as further embodiments of the described compositions and methods. Therefore, the details as set forth herein are hereby incorporated into the detailed description as alternative embodiments. It was surprising and unexpected discovered that the bioplastic polymer or compositions of the present disclosure provides increased/enhanced degradation/biodegradation characteristics, such as marine degradation/biodegradation characteristics (such as, aerobic biodegradation and/or bio-disintegration in seawater), relative to presently known plastics.

### Preparation of Blends.

Blends of polycaprolactone (PCL) and polylactic acid (PLA) will be prepared as shown in Table 1 below. Before the materials are blended, the PCL and PLA are prepared according to the manufacturer's recommendations; PLA will be dried for 4 to 6 hours at 100° C. in a desiccant hot air dryer to reduce moisture content to a level of less than 250 parts per million (ppm), PCL will be dried for 4 to 6 hours at 40° C. in a desiccant hot air dryer to reduce moisture content to a level of less than 250 parts per million (ppm).

PLA and CAPA® Thermoplastic (TP) pellets (CAPA® 6800; INGEVITY UK LTD, Warrington, Chesire, United Kingdom) will be pre-mixed, before being dosed via a gravimetric K-Tron feeder to a ZSK18 twin-screw extruder (Coperion GmbH, Stuttgart, Germany) for compounding. The blend will be heated to facilitate blending. The temperature profile and other process parameters for each blend will depend on the ratio of PLA to CAPA® TP. After compounding, the polymer strand will be cooled in a water bath and pelletized. The pellets will be collected in polyolefin bags and stored until further processing.

Specimens for examination will be prepared from the sample pellets, and include film specimens, specimens for tensile strength examination, specimens for impact examination, and plaques.

TABLE 1
Composition of Samples

| | Polycaprolactone | Polylactic Acid |
|---|---|---|
| Sample No. | (PCL) (wt %) | (PLA) (wt %) |
| 1 | 0 | 100 |
| 2 | 10 | 90 |
| 3 | 20 | 80 |
| 4 | 30 | 70 |
| 5 | 40 | 60 |
| 6 | 50 | 50 |

### Examination of Thermal Properties.

Specimens will be examined via differential scanning calorimetry (DSC) to determine the glass transition temperature, melting, crystallization, specific heat capacity, oxidation behavior and thermal stability. Specimens (about 1 to about 15 mg) will be placed in a closed crucible. The crucible will then be placed into a temperature-controlled DSC cell. A second crucible without sample will be used as a reference specimen. The specimens will be heated and/or cooled at a controlled steady rate and the heat flow monitored to characterize the phase transitions and/or cure reactions as a function of temperature.

Specimens will also be examined via the heat deflection temperature (HDT) test ASTM D648-18 (Standard Test Method for Deflection Temperature of Plastics Under Flexural Load in the Edgewise Position) and/or International Organization for Standardization ISO 75-1:2020 (Plastics—Determination of Temperature of Deflection Under Load) to assess the temperature at which the specimen deforms under a given flexural load (fiber stress). Heat deflection temperature is the temperature at which a standard test bar (ASTM bar is 5″×0.5″×0.25″; ISO edgewise testing is 120 mm×10 mm×4 mm; ISO flatwise testing bar is 80 mm×10 mm×4 mm) deflects a specified distance under a load. It is used to determine short-term heat resistance. The test distinguishes between materials that sustain light loads at high temperatures and those that lose rigidity over a narrow temperature range. The test bars for each specimen will be placed under the deflection measuring device, and a load of 0.45 millipascal (MPa) or 1.80 Mpa is placed on each specimen. The test specimens are then placed in a silicone oil bath where the temperature is raised 2° C. each minute until the specimen deflects 0.25 mm for ASTM, 0.32 mm for ISO flatwise, and 0.34 mm for ISO edgewise.

### Examination of Mechanical Properties.

Tensile strength and/or compressive strength of the specimens will be examined via universal testing machine (UTM). Indentation force deflection (IFD) for a specimen is calculated by determining the force required to deflect a test specimen a percentage of the original thickness of the specimen with a circular indenter. The degree of indentation is measured while the force is applied. Tests will be performed as described in the International Organization for Standardization ISO 527-2:2012 (Plastics—Determination of Tensile Properties—Part 2: Test conditions for molding and extrusion plastics). Samples will be produced with help of an injection molder. This test analyzes the tensile strength, yield strength, and ductility of a material. The force required to break the molded specimen and the extent to which the specimen stretches or elongates to that breaking point are measured.

Viscoelasticity of the specimens will be examined via dynamic mechanical analysis (DMA). A sinusoidal stress is applied to the test specimen and the strain in the material is measured. This allows for the complex modulus to be determined. Variations in the complex modulus can be examined by varying the temperature of the sample or the frequency of the stress. As such, the glass transition temperature of the material and the transitions corresponding to other molecular motions can be determined/identified.

Impact strength of the specimens will be examined via an impact tester. V-notch Charpy impact tests will be conducted under this test, for what injection molded samples will be produced, followed by cutting of the V-notch. Tests will be performed as described in the International Organization for Standardization ISO 179-1:2010 or ISO 179-1:2023 (Plastics—Determination of Charpy impact properties—Part 1: Non-instrumented impact test). Samples will be produced with help of an injection molder, and a subsequent V-notch cut. This test analyses the amount of energy absorbed by the material during fracture—that is, the test examines the kinetic energy required to initiate fracture and continue the fracture until the specimen is broken.

### Examination of Marine Aerobic Biodegradation Analysis.

Biochemical conversion of organic carbon to CO₂ was evaluated via ASTM D6691-17 (Standard Test Method for Determining Aerobic Biodegradation of Plastic Materials in the Marine Environment by a Defined Microbial Consortium or Natural Sea Water Inoculum). In particular, the method is an aqueous aerobic biodegradability test that determines the degree and rate of aerobic biodegradation of plastic materials in seawater by measuring CO₂ evolution. Comparing the amount of CO₂ evolved with the theoretical amount of evolved CO₂ (ThCO₂)-expressed in percentage—is a marker of the level of biodegradation. The maximum level of biodegradation from the plateau phase of the biodegradation curve is the test result. A positive result requires at least 90% biodegradation with a plateau being reached within 6-months. PLA and PHA Biodegradation in the Marine Environment (Publication Number DRRR-2012-1435. State of California: California Department of Resources Recycling and Recovery. 5 Mar. 2012) and Royer et al. utilized the same standard. As discussed above, minimal, if any, marine biodegradation was observed after 365 days in Publication Number DRRR-2012-1435 and no marine biodegradation was observed after 423 days in Royer et al.

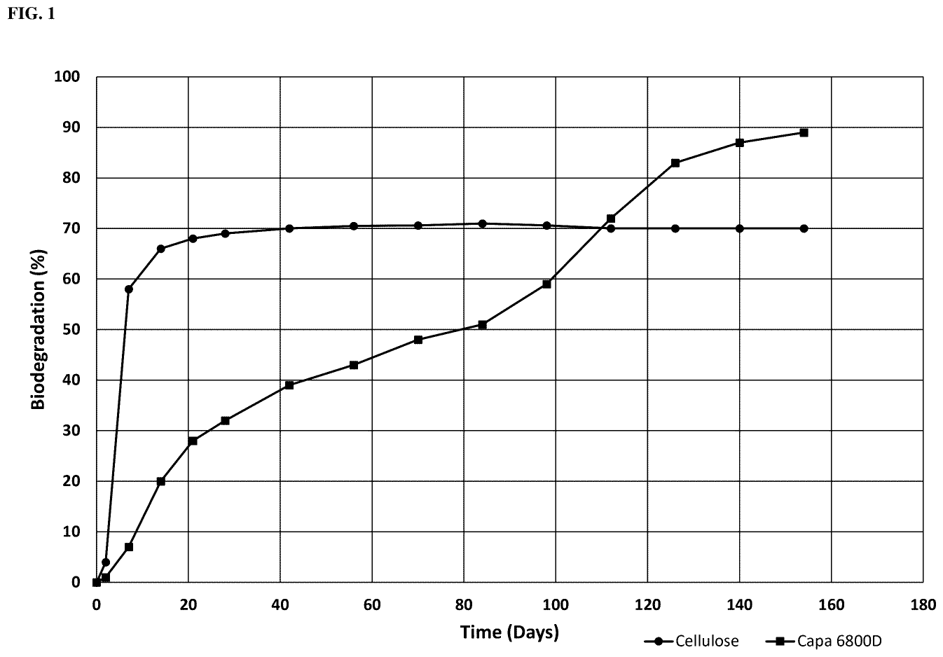

FIG. 1 illustrates the marine aerobic biodegradation of Avicel® native cellulose (SIGMA-ALDRICH, Saint Louis, Missouri) and CAPA® 6800D INGEVITY UK LTD, Warrington, Chesire, United Kingdom) over 154 days.

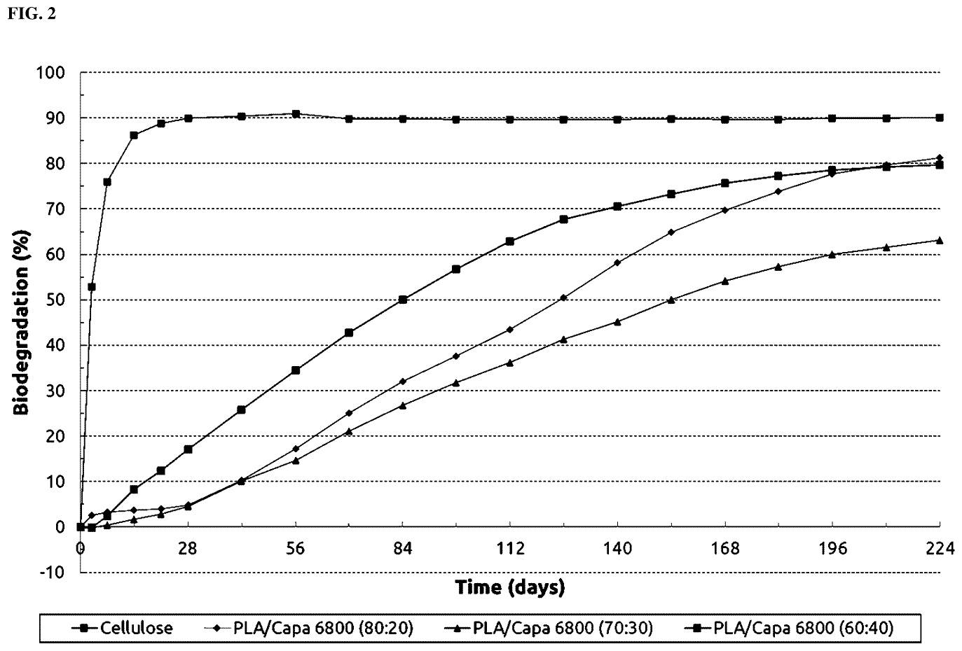

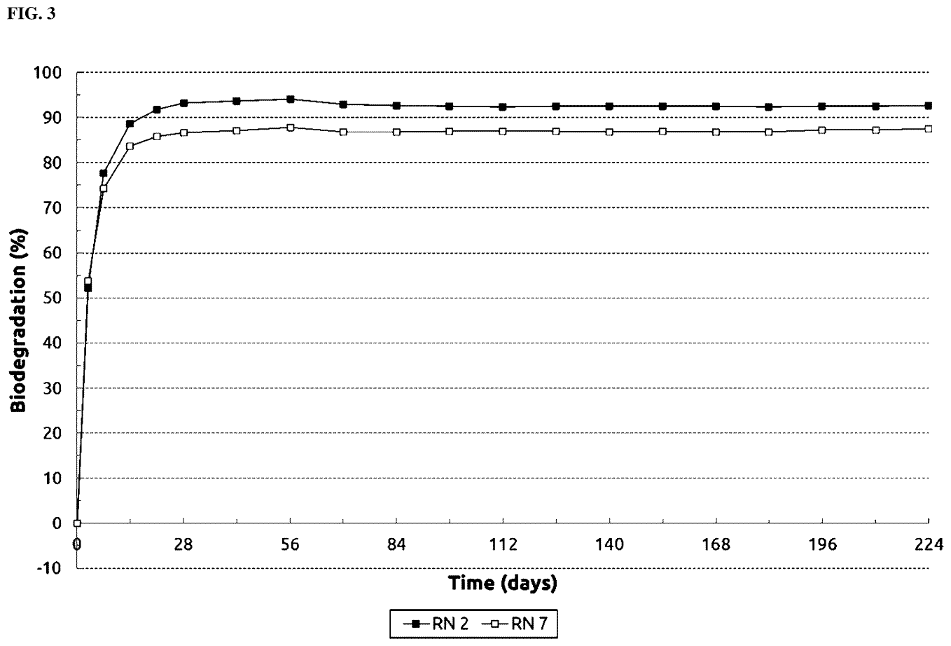

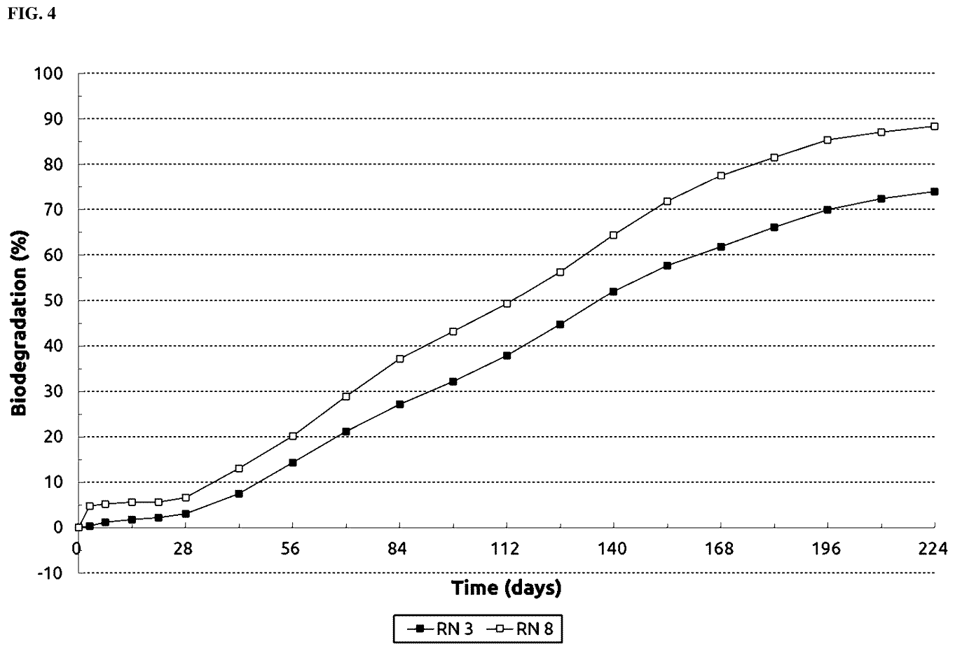

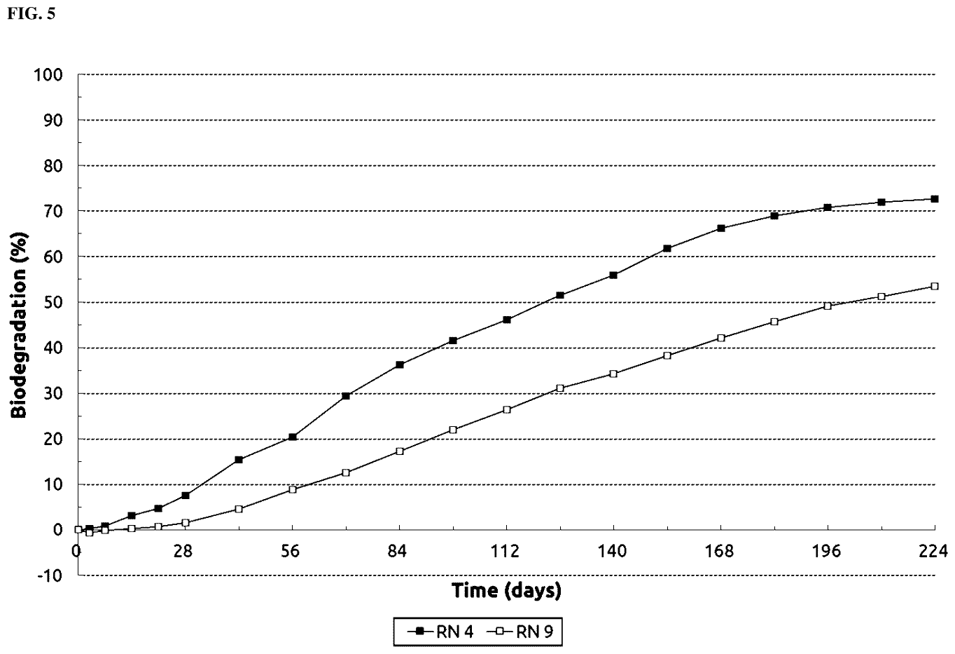

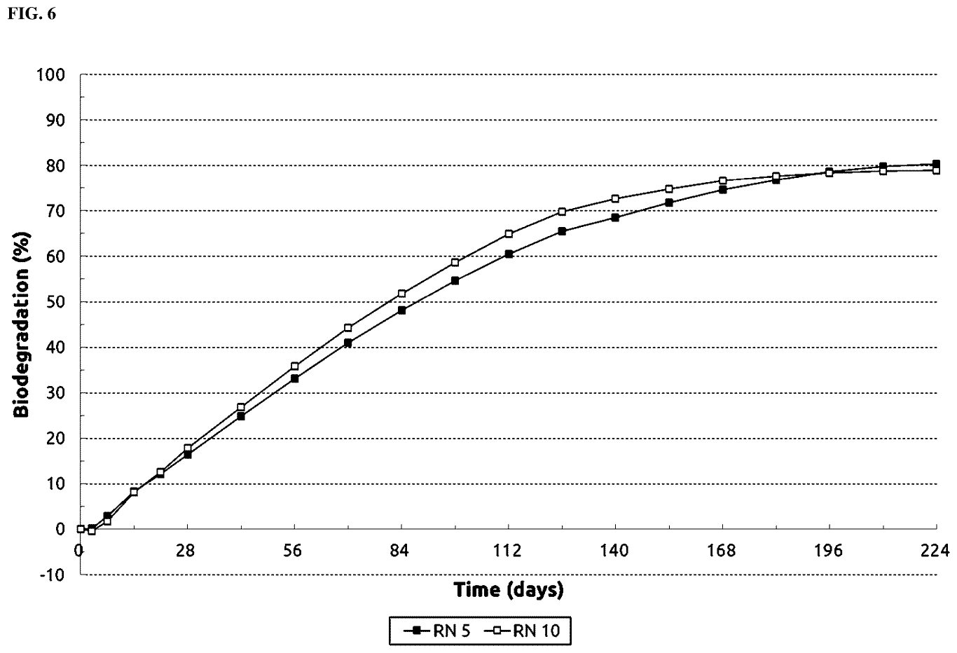

The biodegradation data, total organic carbon content (TOC), and net CO₂ production for Sample 3 (PCL:PLA is 20:80), Sample 4 (PCL:PLA is 30:70), Sample 5 (PCL:PLA is 40:60), and cellulose, are shown in Table 2. FIG. 2 shows the evolution of the average biodegradation percent for the replicates of Sample 3 (PCL:PLA is 20:80), Sample 4 (PCL:PLA is 30:70), Sample 5 (PCL:PLA is 40:60), and cellulose. The raw data for the replicates shown in FIG. 2 are provided in FIG. 3 (cellulose with Replicate No. 2 (RN2) and Replicate No. 7 (RN7)), FIG. 4 (PCL:PLA is 20:80 with Replicate No. 3 (RN3) and Replicate No. 8 (RN8)), FIG. 5 (PCL:PLA is 30:70 with Replicate No. 4 (RN4) and Replicate No. 9 (RN9)), and FIG. 6 (PCL:PLA is 40:60 with Replicate No. 5 (RN5) and Replicate No. 10 (RN10)).

TABLE 2
Total organic carbon content (TOC), net CO₂ production,
and biodegradation after 225 days for Cellulose,
Sample 3, Sample 4, and Sample 5.

| | | Net | Biodegradation (%) | | |
|---|---|---|---|---|---|
| | | CO₂ | | | Relative |
| | TOC | production | | Standard | Biodegrad- |
| Test series | (%) | (mg) | Average | Deviation | ation |
| Cellulose | 42.4 | 84.0 | 90.0 | 3.6 | 100.0 |
| Sample 3 (PLA/ | 53.2 | 95.2 | 81.2 | 10.2 | 90.2 |
| PCL is 80:20) | | | | | |
| Sample 4 (PLA/ | 54.3 | 75.4 | 63.2 | 13.5 | 70.1 |
| PCL is 70:30) | | | | | |
| Sample 5 (PLA/ | 56.2 | 98.5 | 79.7 | 0.9 | 88.5 |
| PCL is 60:40) | | | | | |

As shown in Table 2 and FIGS. 2, an average biodegradation percentage of 89.7% was observed for cellulose after 168 days. As shown in Table 2 and FIG. 2, an average biodegradation percentage of 81.2%, 63.2%, and 79.7%, respectively, was observed for Sample 3 (PCL:PLA is 20:80), Sample 4 (PCL:PLA is 30:70), and Sample 5 (PCL:PLA is 40:60) after 228 days. Also shown in Table 2, a relative biodegradation of 90.2%, 70.1%, and 88.5%, respectively, was observed for Sample 3 (PCL:PLA is 20:80), Sample 4 (PCL:PLA is 30:70), and Sample 5 (PCL:PLA is 40:60) after 225 days.

### Examination of Bio-Disintegration in Seawater.

Physical degradation of sample (film) will be examined via ISO/CD 16636 (Plastics-Disintegration Field Test of Plastics Under Water Environmental Conditions). ISO/CD 16636 determines the degree of disintegration of plastic materials immersed to marine habitats. The method examines sea surface or the coastal area with a depth of at least 3 meters and evaluates the disintegration of a plastic floating in the coastal area. Briefly, the specimen is submerged to a depth of at least 1.5 meters, which reproduces the floating state in seawater. This method examines bio-disintegration, not biodegradation. A positive result requires falling apart and fragmentation of the sample (<2 mm).

### Examination of Daphnia Toxicity.

Toxicity after specimen breakdown will be examined. The OK biodegradable MARINE certification scheme of TÜV AUSTRIA Belgium NV (Rotselaar, Belgium) prescribes that the concentration of material to be tested must be 0.1% on dry mass basis. The test samples will be added in a 0.1% concentration to a chemically defined (mineral) aqueous medium that was spiked with micro-organisms. The control series (mineral aqueous medium spiked with micro-organisms) and the test series will be incubated for 179 days at 30° C. (+2° C.). During the incubation, biodegradation of the test materials can occur. The test will be performed as described in Office of Prevention, Pesticides and Toxic Substances (OPPTS) 850.1010 (Aquatic Invertebrate Acute Toxicity Test, Freshwater Daphnids (1996)) and Organisation for Economic Co-operation and Development (OECD) 202 (Daphnia sp., Acute Immobilisation Test (2004)), taking into account the modifications on concentration and incubation as mentioned in the OK biodegradable MARINE certification scheme. The OK biodegradable MARINE certification scheme prescribes that at least 90% of the tested organisms should remain mobile.

While several embodiments of the invention of the present disclosure have been shown and described herein, it will be understood that such embodiments are provided by way of example only. Numerous variations, changes and substitutions will occur to those skilled in the art without departing from the spirit of the invention. Rather, the present disclosure is to cover all modifications, equivalents, and alternatives falling within the scope of the present disclosure as defined by the following appended claims and their legal equivalents. Accordingly, it is intended that the description and appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients can be varied to optimize the desired effects, additional ingredients can be added, and/or similar ingredients can be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A bioplastic polymer or composition comprising at least one polycaprolactone (PCL) and at least one bioplastic.

2. The bioplastic polymer or composition of claim 2, wherein at least one of:
one or more of the at least one polycaprolactone includes a thermoplastic polycaprolactone;
one or more of the at least one bioplastic includes a polysaccharide-based bioplastic, a protein-based bioplastic, an aliphatic bio-polyester, a bio-derived polyethylene, a lipid-based bioplastic, or a mixture thereof; or
a combination thereof.

3. (canceled)

4. The bioplastic polymer or composition of claim 1, wherein at least one of:
one or more of the at least one bioplastic is derived from polysaccharides lipids, or a mixture thereof;
one or more of the at least one bioplastic is derived from starch, cellulose, straw, woodchips, sawdust, chitosan, alginate, soy protein, gluten, gelatin, oils, fats, vegetable oil, vegetable fat, or a mixture thereof; or
a combination thereof.

5. The bioplastic polymer or composition of claim 1, wherein one or more of the at least one bioplastic includes polylactic acid (PLA) bioplastic, a polyhydroxybutyrate (PHB) bioplastic, a thermoplastic starch (TPS) bioplastic, a poly(1,4-butylene succinate) (PBS) bioplastic, a polyhydroxyalkanoates (PHA) bioplastic, or a mixture thereof.

6. The bioplastic polymer or composition of claim 1, wherein at least one of:
the at least one polycaprolactone is present in an amount of about 5.0 wt % to about 50.0 wt % of the bioplastic polymer or composition;
the at least one bioplastic is present in an amount of about 50.0 wt % to about 95.0 wt % of the bioplastic polymer or composition; or
a combination thereof.

7. (canceled)

8. The bioplastic polymer or composition of claim 1, wherein the bioplastic polymer or composition is a thermoplastic bioplastic polymer or composition.

9. The bioplastic polymer or composition of claim 1, wherein the bioplastic polymer or composition has at least one of:
an acceptable glass transition temperature;
an acceptable melting temperature;
an acceptable crystallization temperature;
an acceptable specific heat capacity;
an acceptable oxidation behavior;
an acceptable thermal stability;
an acceptable tensile strength;
an acceptable compressive strength;
an acceptable impact strength;
an acceptable marine aerobic biodegradation;
an acceptable bio-disintegration in seawater;
an acceptable Daphnia magna toxicity; and
a combination thereof.

10. A bioplastic polymer or composition of claim 1 made by a process comprising:
admixing or mixing at least one polycaprolactone (PCL) and at least one bioplastic to prepare a PCL-bioplastic blend or mixture; and
blending the PCL-bioplastic blend or mixture to produce the bioplastic polymer or composition.

11. A method of making a bioplastic polymer or composition of claim 1, the method comprising:
admixing or mixing at least one polycaprolactone (PCL) and at least one bioplastic to prepare a PCL-bioplastic blend or mixture; and
blending the PCL-bioplastic blend or mixture to produce the bioplastic polymer or composition.

12. The bioplastic polymer or composition of claim 10, wherein blending the PCL-bioplastic blend or mixture includes heating, mixing, or a combination thereof, the PCL-bioplastic blend or mixture.

13. The bioplastic polymer or composition of claim 10, further comprising at least one of:
drying the at least one bioplastic;
heating the at least one bioplastic to about 80° C. to about 120° C.;
extruding the bioplastic polymer or composition; or
a combination thereof.

14. (canceled)

15. (canceled)

16. The bioplastic polymer or composition of claim 13, further comprising cooling the extruded bioplastic polymer or composition.

17. The bioplastic polymer or composition of claim 15, further comprising pelletizing the extruded bioplastic polymer or composition (e.g., bioplastic polymer or composition filament).

18. The bioplastic polymer or composition of claim 10, wherein one or more of the at least one polycaprolactone is a thermoplastic polycaprolactone.

19. The bioplastic polymer or composition of claim 10, wherein one or more of the at least one bioplastic includes a polysaccharide-based bioplastic, a protein-based bioplastic, an aliphatic bio-polyester, a bio-derived polyethylene, a lipid-based bioplastic, or a mixture thereof.

20. The bioplastic polymer or composition of claim 10, wherein;
one or more of the at least one bioplastic is derived from polysaccharides, protein, lipids, or a mixture thereof; or
one or more of the at least one bioplastic is derived from starch, cellulose, straw, woodchips, sawdust, chitosan, alginate, soy protein, gluten, gelatin, oils, facts, vegetable oil, vegetable fat, or a mixture thereof.

21. The bioplastic polymer or composition of claim 10, wherein one or more of the at least one bioplastic includes a polylactic acid (PLA) bioplastic, a polyhydroxybutyrate (PHB) bioplastic, a thermoplastic starch (TPS) bioplastic, a poly(1,4-butylene succinate) (PBS) bioplastic, a polyhydroxyalkanoates (PHA) bioplastic, or a mixture thereof.

22. The bioplastic polymer or composition of claim 10, wherein at least one of:
the at least one polycaprolactone is present in an amount of about 5.0 wt % to about 50.0 wt % of the bioplastic composition;
the at least one bioplastic is present in an amount of about 50.0 wt % to about 95.0 wt % of the bioplastic composition; or
a combination thereof.

23. (canceled)

24. An article comprising, consisting essentially of, or consisting of, the bioplastic polymer or composition of claim 1.

25. The bioplastic polymer or composition of claim 19 wherein the bioplastic polymer or composition has at least one of:
a glass transition temperature within 10.0% of the glass transition temperature of the bioplastic not blended/polymerized with PCL;
a melting temperature within 10.0% of the melting temperature of the bioplastic not blended/polymerized with PCL;
a crystallization temperature within 10.0% of the crystallization temperature of the bioplastic not blended/polymerized with PCL;
a specific heat capacity within 10.0% of the specific heat capacity of the bioplastic not blended/polymerized with PCL;
an oxidation behavior within 10.0% of the oxidation behavior of the bioplastic not blended/polymerized with PCL;
a thermal stability within 10.0% of the thermal stability of the bioplastic not blended/polymerized with PCL;
a tensile strength within 10.0% of the tensile strength of the bioplastic not blended/polymerized with PCL;
a compressive strength within 10.0% of the compressive strength of the bioplastic not blended/polymerized with PCL;
an impact strength within 10.0% of the impact strength of the bioplastic not blended/polymerized with PCL;
at least 90.0% marine aerobic biodegradation with a plateau reached within 6-months);
falls apart and/or fragmentation of <2 mm in seawater;
at least 90.0% of the Daphnia magna test organisms remain mobile; and
a combination thereof.
